(19) United States
(12) Patent Application Publication
(10) Pub. No.: US 2011/0096403 A1
(43) Pub. Date: Apr. 28, 2011

(54) Anti-glare optical module and method for manufacturing the same

(76) Inventors: Lin Cheng, Taipei City (TW); Jen-Huai Chang, Pingjhen City (TW); Jyh Horng Wang, Pingjhen City (TW)

(21) Appl. No.: 12/588,629

(22) Filed: Oct. 22, 2009

(51) Int. Cl. G02B 27/00; G02B 1/12

(52) U.S. Cl. 359/601; 264/1.38

(57) ABSTRACT

An anti-glare optical module includes a substrate unit and a thin film unit. The thin film unit is disposed on the top surface of the substrate unit. The thin film unit has a base surface that has a height relative to the top surface of the substrate unit, the thin film unit has a plurality of convex structures, each convex structure has a curvature radius, the curvature radiuses of every two adjacent convex structures are different, a plurality of lower points each formed between every two convex structures and on the base surface, and each convex structure has an upper point. Therefore, the thin film unit has a good scattering effect for reflective light, can maintain the excellent transmittance and can reduce the flicker points by the convex structures, so that using the convex structures can prevent the eyes of the user from being effected by flicker points.

### BACKGROUND OF THE INVENTION

1. Field of the Invention

The present invention relates to an optical module and a method for manufacturing the same, in particular, to an anti-glare optical module and a method for manufacturing the same.

2. Description of Related Art

In recent years, 3C products are widely used in the daily life, such as notebook computers, LCD TV, etc., thereby promote the market demand of LCD and the related optical materials. Due to high transparency, chemical resistance and dimension stability, the biaxial oriented polyester film is extensively used in various optical film applications; in addition to chemical resistance and dimension stability required by a general polyester film, this optical use polyester film should possesses high transparency, low haze value, good adhesion and anti-locking properties. Generally a coating solution is coated on one side (the label 1′ in FIG. 1) or both sides (the label 2′ in FIG. 1) of polyester films to improve the properties described above as cited in the previous arts, e.g. EP No. 1,178,075 A1; U.S. Pat. No. 6,733,863 B1; U.S. Pat. No. 6,482,501 B2.

In EP No. 1,178,075 A 1, a polyester film with high transparency, low haze and good adhesion is disclosed, its coating formulation comprises some known constitutents including water soluble polyesters, acrylic resins, 0.01˜0.3 μm fine particles and aliphatic amino compounds etc., since these nano- or sub-micron particles have a quite large surface energy, after coating and drying, the nano- or sub-micron particles tend to aggregate into several micron to dozens of micron sized particles to deteriorate transparency, haze and anti-blocking properties of the polyester film, especially the so-called optical defects will be resulted in LCD applications.

U.S. Pat. No. 6,733,863 B1 and U.S. Pat. No. 6,482,501 B2 also mention a polyester film with a low haze value and containing particles smaller than 20 micron, its coating formulation contains some known ingredients, for example, a water soluble copolyester, polyurethanes, and 0.01-4.0 μm fine particles with anti-blocking functions; similarly, after drying, the coated formulation with relatively large surface energy nano/sub-micron fine particles is very facile to aggregate to micron size particles, thereby affects optical properties of polyester films.

Besides, U.S. Pat. No. 6,482,501 B2 emphasizes the filtration of coating solutions to remove particles with the size over 20 μm, apparently its coating solution should have the phenomenon of aggregation; in addition, the said patent also highlights quite good thermo-shrinking dimensional stabilities, but the composition contains a certain degree (10˜90%) of a polyurethane component, its UV light resistance or heat resistance is worse than commonly known polyester or acrylic resin components; facing the critical requirements of LCD, its performance of color tinge, chromatism, etc. is not a suitable choice.

Generally speaking, the transparency, haze and anti-blocking properties of polyester films depend on the crystallinity of the polyester base resin (polyethylene terephthalate, or abbreviated as PET, see the label 1a′ in FIG. 1) and the type and content of the added micron grade anti-locking agents (see the label 1b′ in FIG. 1), and another important factor to be the coated layer on the polyester film. In addition to resins (see the label 2a′ in FIG. 1), generally fine particles (see the label 2b′ in FIG. 1) are incorporated to improve the antiblocking property of polyester films, at the same time, refractive index, surface evenness, etc. of the coated layer are closely linked to the transparency of polyester films, and if the fine particles of the coated layer (see the label 2b′ in FIG. 1) aggregate, voids will be resulted at its circumference after the stretching of the coated layer; all of these aggregation, void and unevenness deteriorate the transparency, haze and anti-blocking properties of polyester films.

### SUMMARY OF THE INVENTION

In view of the aforementioned issues, the present invention provides an anti-glare optical module and a method for manufacturing the same. The present invention provides a thin film that has a plurality of concave structures formed on its top surface in order to scatter light beams and prevent the light beams from projecting directly onto an optical module via the thin film, so that the present invention can provides good visual effect for user.

To achieve the above-mentioned objectives, the present invention provides an anti-glare optical module, including: a substrate unit and a thin film unit. The substrate unit has a top surface. The thin film unit is disposed on the top surface of the substrate unit. The thin film unit has a base surface that has a height relative to the top surface of the substrate unit, the thin film unit has a plurality of convex structures, each convex structure has a curvature radius, the curvature radiuses of every two adjacent convex structures are different, a plurality of lower points each formed between every two convex structures and on the base surface, and the convex structures are arranged as a predetermined shape on the base surface of the thin film unit. In addition, each convex structure has an upper point, each upper point is separated from the base surface by a predetermined distance, and two adjacent distances from the base surface to the two adjacent upper points are different.

To achieve the above-mentioned objectives, the present invention provides a method for manufacturing an anti-glare optical module, including: providing a substrate unit; placing a mold on a bottom side of the substrate unit, wherein the mold has a plurality of concave structures facing the substrate unit, and a receiving space is formed between the substrate unit and the concave structures; only filling the receiving space with an ultraviolet curing resin; curing the ultraviolet curing resin by ultraviolet light in order to harden the ultraviolet curing resin to form a thin film unit positioned on the bottom side of the substrate unit; and removing the mold to expose the thin film unit, wherein the thin film unit has a plurality of convex structures formed on a bottom surface thereof and respectively corresponding the concave structures.

To achieve the above-mentioned objectives, the present invention provides a method for manufacturing an anti-glare optical module, including: providing a substrate unit; only placing an ultraviolet curing resin on the substrate unit; moving a mold to press the ultraviolet curing resin in order to fill a receiving space between the mold and the substrate unit with the ultraviolet curing resin, wherein the mold has a plurality of concave structures facing the ultraviolet curing resin; curing the ultraviolet curing resin by ultraviolet light in order to harden the ultraviolet curing resin to form a thin film unit positioned on a top side of the substrate unit; and removing the mold to expose the thin film unit, wherein the thin film unit has a plurality of convex structures formed on a top surface thereof and respectively corresponding the concave structures.

Therefore, the present invention can increase the usage quality of the optical module (optical plate) without adding any extra micro particles in the ultraviolet curing resin. In addition, because no any extra micro particles are mixed with the ultraviolet curing resin, the transmittance of the ultraviolet curing resin is increased in order to increase the resolution and the definition of the optical module and the cost of the optical module is decreased.

In order to further understand the techniques, means and effects the present invention takes for achieving the prescribed objectives, the following detailed descriptions and appended drawings are hereby referred, such that, through which, the purposes, features and aspects of the present invention can be thoroughly and concretely appreciated; however, the appended drawings are provided solely for reference and illustration, without any intention that they be used for limiting the present invention.

### BRIEF DESCRIPTION OF THE DRAWINGS

FIG. 1 is a cross-sectional view of the polyester film for the application of LCD optical materials according to the prior art;

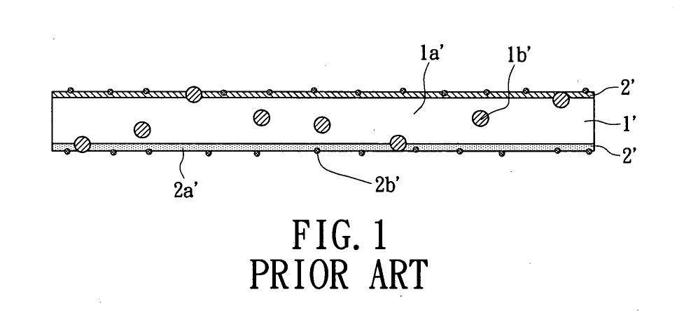

FIG. 2 is a flowchart of the method for manufacturing an anti-glare optical module according to the first embodiment of the present invention;

FIGS. 2A to 2C are schematic views of the method for manufacturing an anti-glare optical module according to the first embodiment of the present invention, at different stages of the manufacturing processes, respectively;

FIG. 3 is a flowchart of the method for manufacturing an anti-glare optical module according to the second embodiment of the present invention;

FIGS. 3A to 3C are schematic views of the method for manufacturing an anti-glare optical module according to the second embodiment of the present invention, at different stages of the manufacturing processes, respectively;

FIG. 4 is a flowchart of the method for manufacturing an anti-glare optical module according to the third embodiment of the present invention;

FIGS. 4A to 4C are schematic views of the method for manufacturing an anti-glare optical module according to the third embodiment of the present invention, at different stages of the manufacturing processes, respectively; and

FIG. 4D is a perspective, schematic view of the anti-glare optical module according to the third embodiment of the present invention.

### DETAILED DESCRIPTION OF THE PREFERRED EMBODIMENTS

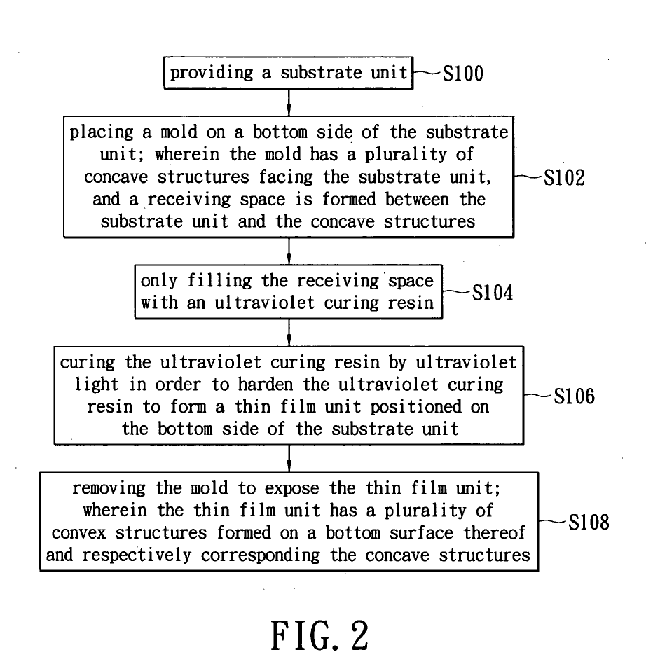

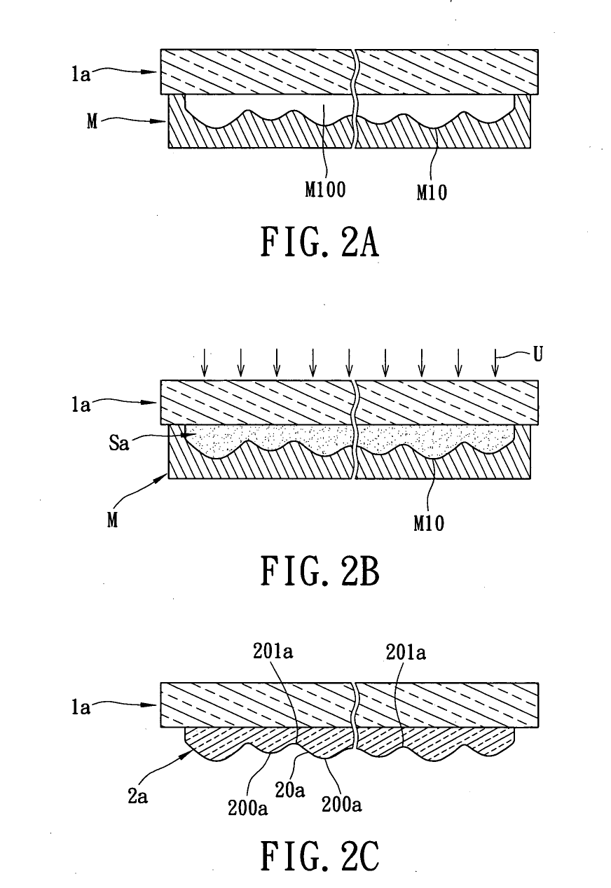

Referring to FIGS. 2 and 2A-2C, the first embodiment of the present invention provides a method for manufacturing an anti-glare optical module, including:

The step S100 is that: referring to FIGS. 2 and 2A, providing a substrate unit 1a. The substrate unit 1a can be a translucent substrate such as translucent acrylic base plate in order to provide a curing path for the ultraviolet light.

The step S102 is that: referring to FIGS. 2 and 2A, placing a mold M on a bottom side of the substrate unit 1a; wherein the mold M has a plurality of concave structures M10 facing the substrate unit 1a, and a receiving space M100 is formed between the substrate unit 1a and the concave structures M10.

The step S104 is that: referring to FIGS. 2 and 2B, only filling the receiving space M100 with an ultraviolet curing resin Sa. In other words, no any extra micro particles are mixed with the ultraviolet curing resin Sa.

The step S106 is that: referring to FIGS. 2, 2B and 2C, curing the ultraviolet curing resin Sa by ultraviolet light U in order to harden the ultraviolet curing resin Sa to form a thin film unit 2a positioned on the bottom side of the substrate unit 1a as shown in FIG. 2C. In other words, the ultraviolet light U passes through the substrate unit 1a to curing the ultraviolet curing resin Sa in order to harden and position the ultraviolet curing resin Sa on the bottom side of the substrate unit 1a.

The step S108 is that: referring to FIGS. 2 and 2C, removing the mold M to expose the thin film unit 2a; wherein the thin film unit 2a has a plurality of convex structures 20a formed on a bottom surface thereof and respectively corresponding the concave structures M10. In addition, the curvature radius of each convex structure 20a is between 0.05 μm and 5 μm, and the average roughness of the convex structures 20a is between 0.01 μm and 5 μm.

Moreover, the curvature radiuses of every two adjacent convex structures 20a are different, and the convex structures 20a are arranged as an irregular shape formed on a top surface of the thin film unit 2a. In addition, each convex structure 20a has an upper point 200a, and the heights of every two adjacent upper points 200a relative to the substrate unit 1a are different. Each of lower points 201a is formed between every two convex structures 20a, and the heights of every two adjacent lower points 201a relative to the substrate unit 1a are different.

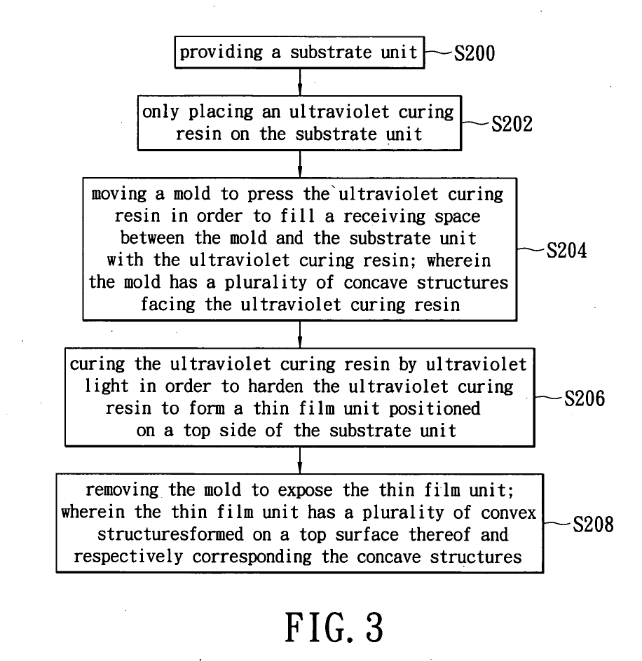

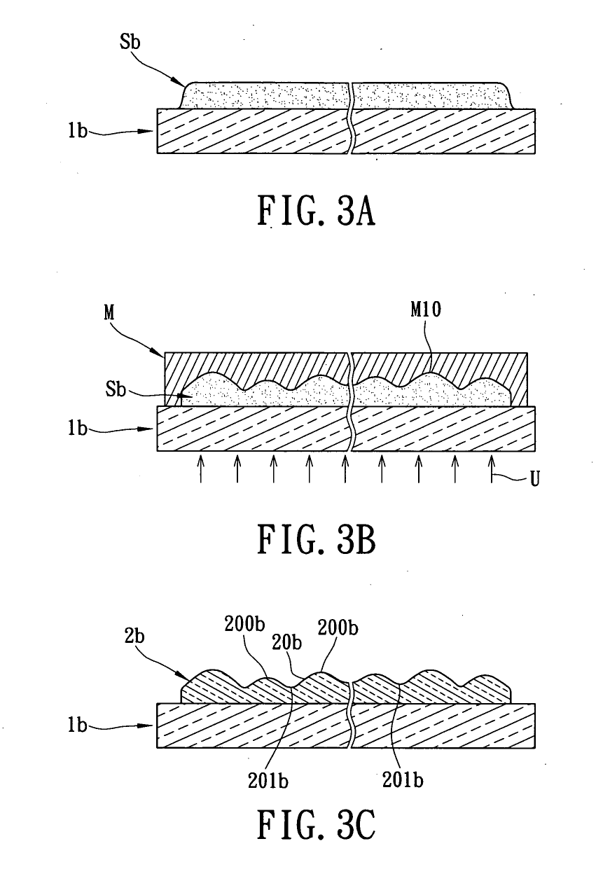

Referring to FIGS. 3 and 3A-3C, the second embodiment of the present invention provides a method for manufacturing an anti-glare optical module, including:

The step S200 is that: referring to FIGS. 3 and 3A, providing a substrate unit 1b. The substrate unit 1b can be a translucent substrate such as translucent acrylic base plate in order to provide a curing path for the ultraviolet light.

The step S202 is that: referring to FIGS. 3 and 3A, only placing an ultraviolet curing resin Sb on the substrate unit 1b. In other words, no any extra micro particles are mixed with the ultraviolet curing resin Sb.

The step S204 is that: referring to FIGS. 3 and 3B, moving a mold M to press the ultraviolet curing resin Sb in order to fill a receiving space between the mold M and the substrate unit 1b with the ultraviolet curing resin Sb; wherein the mold M has a plurality of concave structures M10 facing the ultraviolet curing resin Sb.

The step S206 is that: referring to FIGS. 3, 3B and 3C, curing the ultraviolet curing resin Sb by ultraviolet light U in order to harden the ultraviolet curing resin Sb to form a thin film unit 2b positioned on a top side of the substrate unit 1b as shown in FIG. 3C. In other words, the ultraviolet light U passes through the substrate unit 1b to curing the ultraviolet curing resin Sb in order to harden and position the ultraviolet curing resin Sb on a top side of the substrate unit 1b.

The step S208 is that: referring to FIGS. 3 and 3C, removing the mold M to expose the thin film unit 2b; wherein the thin film unit 2b has a plurality of convex structures 20b formed on a top surface thereof and respectively corresponding the concave structures M10. In addition, the curvature radius of each convex structure 20b is between 0.05 μm and 5 μm, and the average roughness of the convex structures 20b is between 0.01 μm and 5 μm.

Moreover, the curvature radiuses of every two adjacent convex structures 20b are different, and the convex structures 20b are arranged as an irregular shape formed on a top surface of the thin film unit 2b. In addition, each convex structure 20b has an upper point 200b, and the heights of every two adjacent upper points 200b relative to the substrate unit 1b are different. Each of lower points 201b is formed between every two convex structures 20b, and the heights of every two adjacent lower points 201b relative to the substrate unit 1b are different.

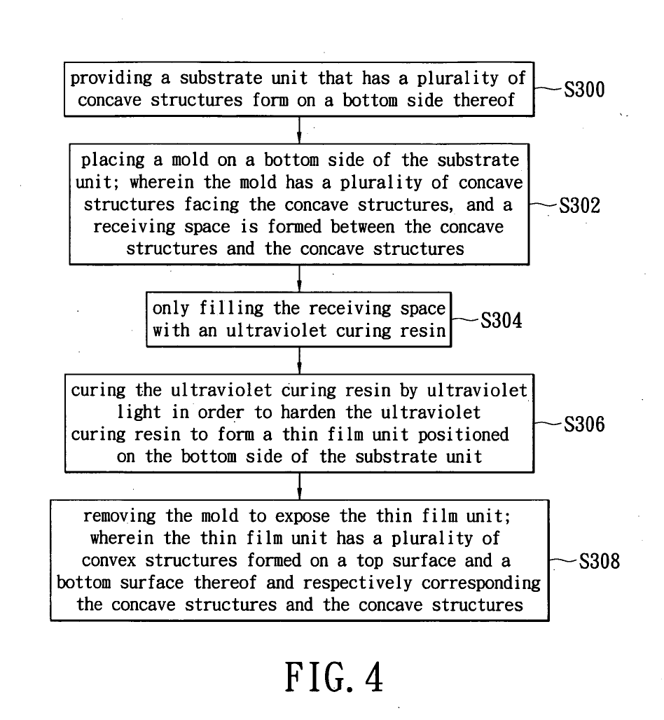

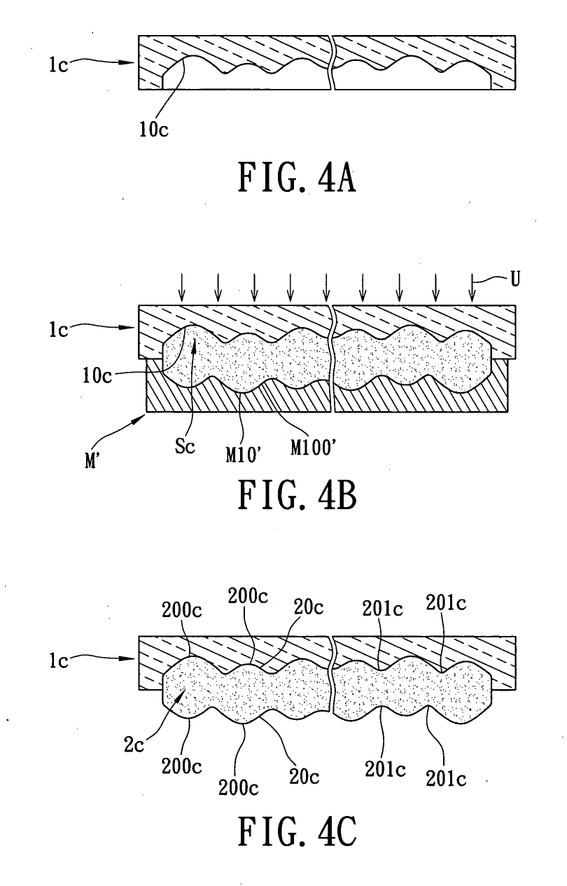

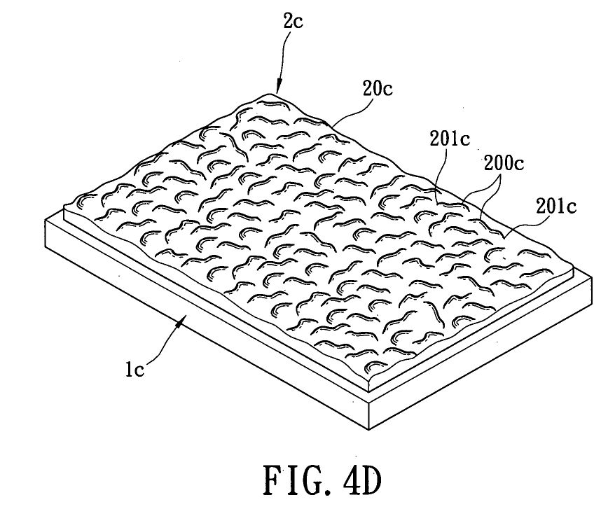

Referring to FIGS. 4 and 4A-4C, the third embodiment of the present invention provides a method for manufacturing an anti-glare optical module, including:

The step S300 is that: referring to FIGS. 4 and 4A, providing a substrate unit 1c that has a plurality of concave structures 10c form on a bottom side thereof. The substrate unit 1c can be a translucent substrate such as translucent acrylic base plate in order to provide a curing path for the ultraviolet light.

The step S302 is that: referring to FIGS. 4 and 4A, placing a mold M′ on a bottom side of the substrate unit 1c; wherein the mold M′ has a plurality of concave structures M10′ facing the concave structures 10c, and a receiving space M100′ is formed between the concave structures 10c and the concave structures M10′.

The step S304 is that: referring to FIGS. 4 and 4B, only filling the receiving space M100′ with an ultraviolet curing resin Sc. In other words, no any extra micro particles are mixed with the ultraviolet curing resin Sc.

The step S306 is that: referring to FIGS. 4, 4B and 4C, curing the ultraviolet curing resin Sc by ultraviolet light U in order to harden the ultraviolet curing resin Sc to form a thin film unit 2c positioned on the bottom side of the substrate unit 1c as shown in FIG. 4C. In other words, the ultraviolet light U passes through the substrate unit 1c to curing the ultraviolet curing resin Sc in order to harden and position the ultraviolet curing resin Sc on the bottom side of the substrate unit 1c.

The step S308 is that: referring to FIGS. 4, 4C and 4D, removing the mold M′ to expose the thin film unit 2c; wherein the thin film unit 2c has a plurality of convex structures 20c formed on a top surface and a bottom surface thereof and respectively corresponding the concave structures 10c and the concave structures M10′. In addition, the curvature radius of each convex structure 20c is between 0.05 μm and 5 μm, and the average roughness of the convex structures 20c is between 0.01 μm and 5 μm.

Moreover, the curvature radiuses of every two adjacent convex structures 20c are different, and the convex structures 20c are arranged as an irregular shape formed on a top surface of the thin film unit 2c. In addition, each convex structure 20c has an upper point 200c, and the heights of every two adjacent upper points 200c are different. Each of lower points 201c is formed between every two convex structures 20c, and the heights of every two adjacent lower points 201c are different.

However, the above-mentioned method for arranging the convex structures and the design of height difference for every two adjacent upper points and every two adjacent lower points are just examples in the present invention. For example, in the first embodiment, the heights of every two adjacent upper points 200a and every two adjacent lower points 201a can be the same.

Therefore, the present invention provides an anti-glare optical module by the above-mentioned manufacturing method. For example, in the first embodiment, the anti-glare optical module includes a substrate unit 1a and a thin film unit 2a formed by matching the forming of the mold M and the curing of the ultraviolet light U.

In addition, the thin film unit 2a is only made of ultraviolet curing resin Sa that is hardened by ultraviolet light U (it means that no any extra micro particles are mixed with the ultraviolet curing resin Sa) and is disposed on the top surface of the substrate unit 1a. Furthermore, the thin film unit 2a has a base surface that has a height relative to the top surface of the substrate unit 1a, and the thin film unit 2a has a plurality of convex structures 20a. The curvature radius of each convex structure 20a is between 0.05 μm and 5 μm, and the average roughness of the convex structures 20a is between 0.01 μm and 5 μm.

The different curvature radius and average roughness can generate different results as shown in the following tables:

| Curvature | Reflex ratio of | | | | |
|---|---|---|---|---|---|
| radius of | light passing | | | | Environ- |
| each convex | the convex | Fog | | | mental |
| structure | structure | grade | Image | Flicker | light |
| (μm) | (%) | (Hz) | sharpness | point | resistance |
| <0.05 | 93% | 0.11% | ◯ | ◯ | □ |
| 1 | 92% | 0.13% | ◯ | ◯ | ◯ |
| >5 | 90% | 0.20% | □ | □ | ◯ |

| Average | Reflex ratio of | | | | |
|---|---|---|---|---|---|
| roughness of | light passing | | | | Environ- |
| each convex | the convex | Fog | Image | | mental |
| structure | structure | grade | sharp- | Flicker | light |
| (μm) | (%) | (Hz) | ness | point | resistance |
| <0.01 | 91% | 0.13% | ◯ | ◯ | □ |
| 0.78 | 91% | 0.13% | ◯ | ◯ | ◯ |
| >5 | 90% | 0.20% | □ | □ | ◯ |

Moreover, if the inner surface of the mold M is composed of a plurality continuous curved surfaces or spherical surfaces, the curvature radius of each convex structure is between 0.05 μm and 5 μm, the range between 0.1 μm and 3 μm is better and the range between 0.2 μm and 1.5 μm is best. If the mold M has a plurality concave structures formed on the inner surface thereof, the average roughness (Ra) of each convex structure is between 0.01 μm and 5 μm, the range between 0.05 μm and 1 μm is better and the range between 0.1 μm and 0.5 μm is best. In addition, the mold M can be manufactured by mechanical processing, chemical etching, laser processing, discharge processing or electroforming etc.

In conclusion, the inner surface of the mold is composed of a plurality continuous curved surfaces or spherical surfaces, so that not only the thin film unit has a good scattering effect for reflective light, but also the excellent transmittance of 93% can be maintained. In addition, the flicker points can be reduced by the convex structures, so that using the convex structures can prevent the eyes of the user from being effected by flicker points.

The above-mentioned descriptions merely represent solely the preferred embodiments of the present invention, without any intention or ability to limit the scope of the present invention which is fully described only within the following claims. Various equivalent changes, alterations or modifications based on the claims of present invention are all, consequently, viewed as being embraced by the scope of the present invention.

What is claimed is:

1. An anti-glare optical module, comprising:
a substrate unit having a top surface; and
a thin film unit disposed on the top surface of the substrate unit, wherein the thin film unit has a base surface that has a height relative to the top surface of the substrate unit, the thin film unit has a plurality of convex structures, each convex structure has a curvature radius, the curvature radiuses of every two adjacent convex structures are different, a plurality of lower points each formed between every two convex structures and on the base surface, and the convex structures are arranged as a predetermined shape on the base surface of the thin film unit;
wherein each convex structure has an upper point, each upper point is separated from the base surface by a predetermined distance, and two adjacent distances from the base surface to the two adjacent upper points are different.

2. The anti-glare optical module according to claim 1, wherein the substrate unit is an acrylic base plate.

3. The anti-glare optical module according to claim 1, wherein the thin film unit is made of an ultraviolet curing resin.

4. The anti-glare optical module according to claim 1, wherein the curvature radius of each convex structure is between 0.05 μm and 5 μm, and the average roughness of the convex structures is between 0.01 μm and 5 μm.

5. A method for manufacturing an anti-glare optical module, comprising:
providing a substrate unit;
placing a mold on a bottom side of the substrate unit, wherein the mold has a plurality of concave structures facing the substrate unit, and a receiving space is formed between the substrate unit and the concave structures;
only filling the receiving space with an ultraviolet curing resin;
curing the ultraviolet curing resin by ultraviolet light in order to harden the ultraviolet curing resin to form a thin film unit positioned on the bottom side of the substrate unit; and
removing the mold to expose the thin film unit, wherein the thin film unit has a plurality of convex structures formed on a bottom surface thereof and respectively corresponding the concave structures.

6. The method according to claim 5, wherein the substrate unit is an acrylic base plate, and the substrate unit is translucent in order to provide a curing path for the ultraviolet light to harden the ultraviolet curing resin.

7. The method according to claim 5, wherein the curvature radius of each convex structure is between 0.05 μm and 5 μm, and the average roughness of the convex structures is between 0.01 μm and 5 μm.

8. The method according to claim 5, wherein the curvature radiuses of every two adjacent convex structures are different

9. The method according to claim 5, wherein the convex structures are arranged as an irregular shape formed on a top surface of the thin film unit.

10. The method according to claim 5, wherein each convex structure has an upper point, and the heights of every two adjacent upper points relative to the substrate unit are different.

11. The method according to claim 5, wherein a plurality of lower points each formed between every two convex structures, and the heights of every two adjacent lower points relative to the substrate unit are different.

12. A method for manufacturing an anti-glare optical module, comprising:
providing a substrate unit;
only placing an ultraviolet curing resin on the substrate unit;
moving a mold to press the ultraviolet curing resin in order to fill a receiving space between the mold and the substrate unit with the ultraviolet curing resin, wherein the mold has a plurality of concave structures facing the ultraviolet curing resin;
curing the ultraviolet curing resin by ultraviolet light in order to harden the ultraviolet curing resin to form a thin film unit positioned on a top side of the substrate unit; and
removing the mold to expose the thin film unit, wherein the thin film unit has a plurality of convex structures formed on a top surface thereof and respectively corresponding the concave structures.

13. The method according to claim 12, wherein the substrate unit is an acrylic base plate, and the substrate unit is translucent in order to provide a curing path for the ultraviolet light to harden the ultraviolet curing resin.

14. The method according to claim 12, wherein the curvature radius of each convex structure is between 0.05 μm and 5 μm, and the average roughness of the convex structures is between 0.01 μm and 5 μm.

15. The method according to claim 12, wherein the curvature radiuses of every two adjacent convex structures are different

16. The method according to claim 12, wherein the convex structures are arranged as an irregular shape formed on a top surface of the thin film unit.

17. The method according to claim 12, wherein each convex structure has an upper point, and the heights of every two adjacent upper points relative to the substrate unit are different.

18. The method according to claim 12, wherein a plurality of lower points each formed between every two convex structures, and the heights of every two adjacent lower points relative to the substrate unit are different.
